(19) United States
(12) Patent Application Publication
(10) Pub. No.: US 2006/0008053 A1
(43) Pub. Date: Jan. 12, 2006

(54) X-ray tube operating state acquiring device, x-ray tube operating state acquiring system, and x-ray tube operating state acquiring method

(76) Inventors: Masayoshi Ishikawa, Hamamatsu-shi (JP); Takane Yokoi, Hamamatsu-shi (JP); Tsutomu Nakamura, Hamamatsu-shi (JP); Yutaka Ochiai, Hamamatsu-shi (JP); Kinji Takase, Hamamatsu-shi (JP)

Correspondence Address: MORGAN LEWIS & BOCKIUS LLP, 1111 PENNSYLVANIA AVENUE NW, WASHINGTON, DC, 20004, US

(21) Appl. No.: 10/512,434

(22) PCT Filed: Apr. 24, 2003
(86) PCT No.: PCT/JP03/05249

§ 371 Date: Aug. 2, 2005

(30) Foreign Application Priority Data
Apr. 24, 2002 (JP) 2002-122917

(51) Int. Cl. H05G 1/32

(52) U.S. Cl. 378/111

(57) ABSTRACT

An X-ray tube controller measures operation information (filament power supply time in an X-ray tube and a grid voltage value applied to grid electrodes to maintain the tube current value under a predetermined tube voltage). The information is transmitted to an X-ray tube operation information acquiring unit via a communication line. In a storage section of the information acquiring unit, a database written with degree of attrition corresponding to the integrated power supply time of a filament (reduction ratio of thermalelectron emission amount (tube current value at a predetermined G1 voltage) to the initial value (thermalelectron emission amount when the filament is first used) is stored. An attrition degree determination section determines the degree of attrition of the filament from the count of filament power supply time with reference to the database. Also, the attrition degree determination section determines the end of life from the G1 voltage value.

### TECHNICAL FIELD

The present invention relates to an X-ray tube operation status acquiring unit, an X-ray tube operation status acquiring system and an X-ray tube operation status acquiring method.

### BACKGROUND ART

Manufacturers or maintenance services providers of X-ray tube are required to detect the cause of failure on X-ray tube. That is, it is required to detect attrition of parts or occurrence of abnormal operation on X-ray tube and to replace or repair the parts of the X-ray tube. Conventionally, the determination of degree of attrition of parts and detection of occurrence of abnormal operation are carried out in a manual manner.

To determine the degree of attrition of parts or to detect occurrence of abnormal operation, it is useful to collect operation information about the operation status of the X-ray tube, which is used for determining of the degree of attrition of parts or detecting occurrence of abnormal operation. Conventionally, service person goes regularly to the installation site of the X-ray tube, and collects the operation information.

### DISCLOSURE OF THE INVENTION

However, there resides such problem in the conventional method that considerable work and time are required for detecting the cause of failure of the X-ray tube.

The present invention has been proposed to solve the above problems. An object of the present invention is to provide an X-ray tube operation status acquiring unit, an X-ray tube operation status acquiring system and an X-ray tube operation status acquiring method, which enables to detect the cause of failure of X-ray tube with a small work and time.

To achieve the above object, an X-ray tube operation status acquiring unit according to the present invention comprises receiving means for receiving operation information about operation status of an X-ray tube transmitted from an X-ray tube measuring apparatus for measuring the operation status of the X-ray tube via a communication line, and storing means for storing the operation information received by the receiving means.

Also, to achieve the above object, an X-ray tube operation status acquiring method according to the present invention comprises a receiving step in which receiving means receives operation information about operation status of the X-ray tube transmitted from an X-ray tube measuring apparatus for measuring the operation status of the X-ray tube via a communication line, and a storing step in which storing means stores the operation information received by the receiving means.

After the receiving means obtains the operation information about the operation status of the X-ray tube measured by X-ray tube measuring apparatus via the communication line, the storing means stores the operation information. Accordingly, it is possible for service person to detect the cause of failure on the X-ray tube without necessity of going to the installation site to inspect the X-ray tube. As a result, the cause of failure of the X-ray tube can be detected with small work and time.

In the X-ray tube operation status acquiring unit and the X-ray tube operation status acquiring method according to the present invention, the operation information preferably includes filament power supply time.

The filament deteriorates in proportion to the power supply time. Since the operation information includes the filament power supply time, the deterioration of the filament can be detected from the count of the filament power supply time.

In the X-ray tube operation status acquiring unit and the X-ray tube operation status acquiring method according to the present invention, the operation information preferably includes a level of a grid voltage applied to grid electrodes so as to maintain the value of the tube current flowing to a target to a certain level in a state where a predetermined tube voltage is applied to the target of the X-ray tube.

When the filament deteriorates, to maintain the specific tube current value in a state where a predetermined tube voltage is applied thereto, the grid voltage has to be increased. The deterioration of the filament can be detected from the level of the grid voltage included in the operation information.

In the X-ray tube operation status acquiring unit and the X-ray tube operation status acquiring method according to the present invention, the operation information preferably includes X-ray irradiation time.

The target deteriorates in proportion to the X-ray irradiation time. Since the operation information includes the X-ray irradiation time, the deterioration of the target can be detected from the count of the X-ray irradiation time.

In the X-ray tube operation status acquiring unit and the X-ray tube operation status acquiring method according to the present invention, the operation information preferably includes a strength of the X-ray generated by thermoelectron collided with the target in a state where a predetermined tube voltage is applied to the target of the X-ray tube and a predetermined tube current flows to the target.

When the target deteriorates, the strength of the X-ray generated under a specific tube voltage value and tube current value decreases. The deterioration of the target can be detected from the strength of the X-ray included in the operation information.

The X-ray tube operation status acquiring unit according to the present invention preferably comprises attrition degree determination means for determining the degree of attrition of component constituting the X-ray tube based on the operation information. Also, the X-ray tube operation status acquiring method according to the present invention preferably comprises an attrition degree determination step in which attrition degree determination means determines the degree of attrition of component constituting the X-ray tube based on the operation information.

Since the attrition degree determination means determines the degree of attrition of the component constituting the X-ray tube based on the operation information, work and time for analyzing the operation information can be eliminated.

The X-ray tube operation status acquiring unit according to the present invention preferably comprises determination result notifying means for notifying determination result by the attrition degree determination means to an information communication terminal via a communication line.

Also, the X-ray tube operation status acquiring method according to the present invention preferably comprises a determination result notifying step, in which determination result notifying means notifies determination result by the attrition degree determination means to an information communication terminal via a communication line.

Since the determination result notifying means notifies the determination result by the attrition degree determination means to the information communication terminal via the communication line, it is possible to notify the necessity of preparation for component replacement to the user without requiring work or time.

The X-ray tube operation status acquiring unit according to the present invention preferably comprises abnormal operation detecting means for detecting abnormal operation of the X-ray tube based on the operation information.

Further, the X-ray tube operation status acquiring method according to the present invention preferably comprises an abnormal operation detecting step, in which abnormal operation detecting means detects abnormal operation of the X-ray tube based on the operation information.

Since the abnormal operation detecting means determines abnormal operation of the X-ray tube based on the operation information, work and time for analyzing the operation information can be eliminated.

In the X-ray tube operation status acquiring unit according to the present invention, the operation information preferably includes a strength of the X-ray generated by thermoelectron collided with the target of the X-ray tube in a state where a predetermined tube voltage is applied to the target of the X-ray tube and a predetermined tube current flows to the target; the abnormal operation detecting means preferably detects occurrence of electric discharge phenomenon in the X-ray tube based on the strength of the X-ray.

Further, in the X-ray tube operation status acquiring method according to the present invention, the operation information preferably includes a strength of the X-ray generated by thermoelectron collided with the target of the X-ray tube in a state where a predetermined tube voltage is applied to the target of the X-ray tube and a predetermined tube current flows to the target; the abnormal operation detecting means preferably detects occurrence of electric discharge phenomenon in the X-ray tube based on the strength of the X-ray.

When electric discharge phenomenon occurs in the X-ray tube, since the target deteriorates, the strength of the X-ray generated under a specific tube voltage value and the tube current value decreases. Since the strength of the X-ray included in the operation information decreases sharply, the occurrence of electric discharge phenomenon in the X-ray tube can be detected.

The X-ray tube operation status acquiring unit according to the present invention preferably comprises detection result notifying means for notifying detection result by the abnormal operation detecting means to an information communication terminal via a communication line.

Further, the X-ray tube operation status acquiring method according to the present invention preferably comprises a detection result notifying step, in which detection result notifying means notifies detection result by the abnormal operation detecting means to an information communication terminal via a communication line.

Since the detection result notifying means notifies the detection result by the abnormal operation detecting means to the information communication terminal via the communication line, the occurrence of abnormal operation can be notified to the user without any work or time.

The X-ray tube operation status acquiring unit according to the present invention preferably comprises presentation means for presenting the operation information stored in the storing means on a display.

Also, the X-ray tube operation status acquiring method according to the present invention preferably comprises a presentation step, in which presentation means presents the operation information stored in the storing means on a display.

Since the presentation means presents the operation information stored in the storing means on the display, service person can readily collect the information about the operation status of the X-ray tube.

To achieve the above object, X-ray tube operation status acquiring system according to the present invention is an X-ray tube operation status acquiring system for controlling operation of X-ray tube, comprising: an X-ray tube measuring apparatus including measuring means for measuring operation status of the X-ray tube and transmission means for transmitting operation information of the X-ray tube obtained by the measuring means by measuring the operation status of the X-ray tube to an information communication terminal via a communication line, and X-ray tube operation status acquiring unit as in any of claims 1-17, wherein receiving means of the X-ray tube operation status acquiring unit receives the operation information transmitted by transmission means of the X-ray tube measuring apparatus; storing means of the X-ray tube operation status acquiring unit stores the operation information received by the receiving means of the X-ray tube operation status acquiring unit.

To achieve the above object, another aspect of the X-ray tube operation status acquiring unit according to the present invention is an X-ray tube operation status acquiring unit for obtaining operation information about operation status of an X-ray tube equipped with a filament for emitting thermoelectron by being supplied with power, comprising: inputting means for inputting operation information of the X-ray tube outputted from an X-ray tube measuring apparatus for measuring operation status of the X-ray tube and including at least filament power supply time and value of grid voltage applied to grid electrodes so as to maintain the value of tube current flowing to a target in a state where a predetermined tube voltage is applied to the target of the X-ray tube, and an attrition degree determination means for determining degree of attrition of the filament based on the filament power supply time and the grid voltage value.

Also, another aspect of the X-ray tube operation status acquiring unit according to the present invention is an X-ray tube operation information acquiring method for obtaining operation information about operation status of an X-ray tube equipped with a filament for emitting thermoelectron by being supplied with power, comprising: a first step for obtaining operation information of the X-ray tube outputted from an X-ray tube measuring apparatus for measuring operation status of the X-ray tube and including at least filament power supply time and value of grid voltage applied to grid electrodes so as to maintain the value of tube current flowing to a target in a state where a predetermined tube voltage is applied to the target of the X-ray tube, and a second step for determining degree of attrition of the filament based on the filament power supply time and the grid voltage value.

The degree of attrition of the filament can be determined from the filament power supply time included in the operation information. Further, the attrition of the filament can be determined more precisely from the grid voltage value included in the operation information. Accordingly, the attrition of the filament can be detected with a small work and time.

To achieve the above object, further another aspect of the X-ray tube operation status acquiring unit of the present invention is an X-ray tube operation status acquiring unit for obtaining operation information about operation status of an X-ray tube, comprising: inputting means for inputting operation information of the X-ray tube outputted from an X-ray tube measuring apparatus for measuring operation status of the X-ray tube and including at lest X-ray irradiation time and strength of X-ray generated by thermoelectron collided with a target in a state where a predetermined tube voltage is applied to the target of the X-ray tube and a predetermined tube current flows to the target, and attrition degree determination means for determining degree of attrition of the target based on the X-ray irradiation time and the strength of the X-ray.

Also, further another aspect of the X-ray tube operation status acquiring method according to the present invention is an X-ray tube operation information acquiring method for obtaining operation information about operation status of an X-ray tube, comprising: a first step for obtaining operation information of the X-ray tube outputted from an X-ray tube measuring apparatus for measuring operation status of the X-ray tube and including at lest X-ray irradiation time and strength of X-ray generated by thermoelectron collided with a target in a state where a predetermined tube voltage is applied to the target of the X-ray tube and a predetermined tube current flows to the target, and a second step for determining degree of attrition of the target based on the X-ray irradiation time and the strength of the X-ray.

The degree of the attrition of the target can be determined from the X-ray irradiation time included in the operation information. Further, the attrition of the target can be determined more precisely from the strength of the X-ray included in the operation information. Accordingly, the attrition of the target can be detected with a small work and time.

### BRIEF DESCRIPTION OF THE DRAWINGS

FIG. 1 is a view schematically showing the structure of an X-ray tube 1 (sectional view);

FIG. 2 is a diagram showing the functional configuration of an X-ray tube operation status acquiring system according to a first embodiment;

FIG. 3 is a diagram showing the content of a file 321 about the attrition degree determination of a filament of the X-ray tube 1 included in operation information;

FIG. 4 is a diagram showing the content of a file 322 about the relationship between G1 voltage value (initial value) and tube current value of the X-ray tube 1, which is stored in a storage section 320 beforehand;

FIG. 5 is a diagram showing the content of a file 323 about the X-ray irradiation time of the X-ray tube 1 included in the operation information;

FIG. 6 is a diagram showing the content of a file 324 about the over-time changes of the tube voltage value and tube current value included in the operation information;

FIG. 7 is a diagram showing the content of a file 325 about the relationship among the tube voltage value, the tube current value and the X-ray dosage (initial value) of the X-ray tube 1, which is stored in the storage section 320 beforehand;

FIG. 8 is a diagram showing the content of a file 326 about the tube voltage value, the tube current value and the X-ray dosage included in the operation information;

FIG. 9 is a diagram showing the functional configuration of an X-ray tube operation status acquiring system according to a second embodiment; and

FIG. 10A is a graph showing the filament power supply time; FIG. 10B is a graph showing the X-ray irradiation time; FIG. 10C is a graph showing the changes of the G1 voltage value; and FIG. 10D is a graph showing the changes of X-ray dosage (strength of the X-ray).

### BEST MODES FOR CARRYING OUT THE INVENTION

Hereinafter, referring to the attached drawings, preferred embodiments of an X-ray tube operation status acquiring unit, an X-ray tube operation status acquiring system and an X-ray tube operation status acquiring method of the present invention will be described in detail.

### First Embodiment

First of all, the structure and the operation of an X-ray tube 1, which is controlled by the X-ray tube operation status acquiring system of a first embodiment will be described.

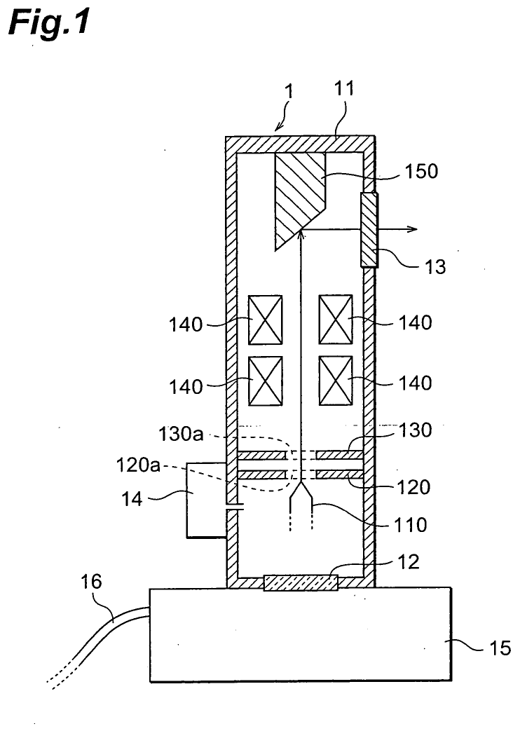

FIG. 1 is a view schematically showing the structure of the X-ray tube 1 (sectional view). As shown in FIG. 1, the X-ray tube 1 is sealed by an outer shell, which comprises a metal housing 11, a stem 12 and a beryllium window 13. The X-ray tube 1 is provided with a vacuum pump 14. Before activating the X-ray tube 1, gases within the outer shell are discharged by the vacuum pump 14. When the X-ray tube 1 is a sealed type, the inside of the outer shell is sealed in vacuum beforehand.

The X-ray tube 1 comprises, inside the outer shell, a filament 110 for emitting thermoelectron by being supplied with power, a first grid electrode 120 for thrusting back the thermoelectron toward the filament, a second grid electrode 130 for pulling the thermoelectron toward the target, electromagnetic lenses 140 for focusing the beam of thermoelectron and a target 150 made of tungsten for generating X-ray by the thermoelectron collided therewith. The first grid electrode 120, the second grid electrode 130 and the electromagnetic lens 140 are disposed in this order from the filament 110 toward the target 150. The first grid electrode 120 and the second grid electrode 130 are provided with an opening 120a and an opening 130a respectively for allowing the thermoelectron to pass through in the center thereof.

The X-ray tube 1 is provided with a power supply 15, which includes a high voltage generating circuit for applying a positive high voltage to the target 150.

The X-ray tube 1 is connected to an X-ray tube controller 2, which will be described later, via a control cable 16, and is controlled by the X-ray tube controller 2.

When the power switch 21 of the X-ray tube controller 2 turns ON (X-ray irradiation switch 22 is OFF), each part of the X-ray tube 1 is supplied with power and the X-ray tube 1 begins to operate. When the filament 110 is applied with a predetermined voltage and supplied with power, the thermoelectron is emitted. Also, the X-ray tube 1 begins warming up, and the level of the voltage (tube voltage) applied to the target 150 gradually increases up to a preset tube voltage value. Further the voltage, which is applied to the first grid electrode 120, is controlled so that the current (tube current), which flows to the target 150, reaches a preset tube current value.

When the warming up is terminated, a negative voltage (cut-off voltage) is applied to the first grid voltage 110, and the X-ray tube 1 gets ready to irradiate the X-ray. At this time, the thermoelectron emitted from the filament 110 is pulled by the second grid electrode 130, which has a potential higher than that of the filament 110. At the same time, since a cut-off voltage is applied to the first grid electrode 120, the thermoelectron is held so as not to pass through the opening 120a of the first grid electrode 120.

When the X-ray irradiation switch 22 of the X-ray tube controller 2 turns ON, the voltage value of the first grid electrode 120 rises, the thermoelectron is pulled by the second grid electrode 130; and thus, the thermoelectron passes through the opening 120a of the first grid electrode 120. Further, being accelerated by the tube voltage applied to the target 150, the thermoelectron passes through the opening 130a of the second grid electrode 130. And when the X-ray irradiation switch 22 turns ON, by controlling the level of the voltage (G1 voltage) applied to the first grid electrode, the amount of the thermoelectron passing through the openings 120a and 130a can be increased or reduced. That is, by controlling the level of the G1 voltage, the strength of the tube current can be increased or reduced.

When the thermoelectron beam focused by the electromagnetic lens 140 collides with the target 150, the target 150 generates X-ray. The X-ray passes through the beryllium window 130 and goes out to the outside of the X-ray tube 1. The strength of the X-ray generated by the target 150 depends on the level of the tube voltage and the strength of the tube current.

The X-ray tube, which is controlled by the X-ray tube operation status acquiring system of the first embodiment, may be a sealed type or an open type. In the X-ray tube 1, by supplying power to the filament, the thermoelectron is emitted. An X-ray tube provided with an indirectly heated thermoelectron generator, which emits thermoelectron by heating the cathode by a heater, may be employed.

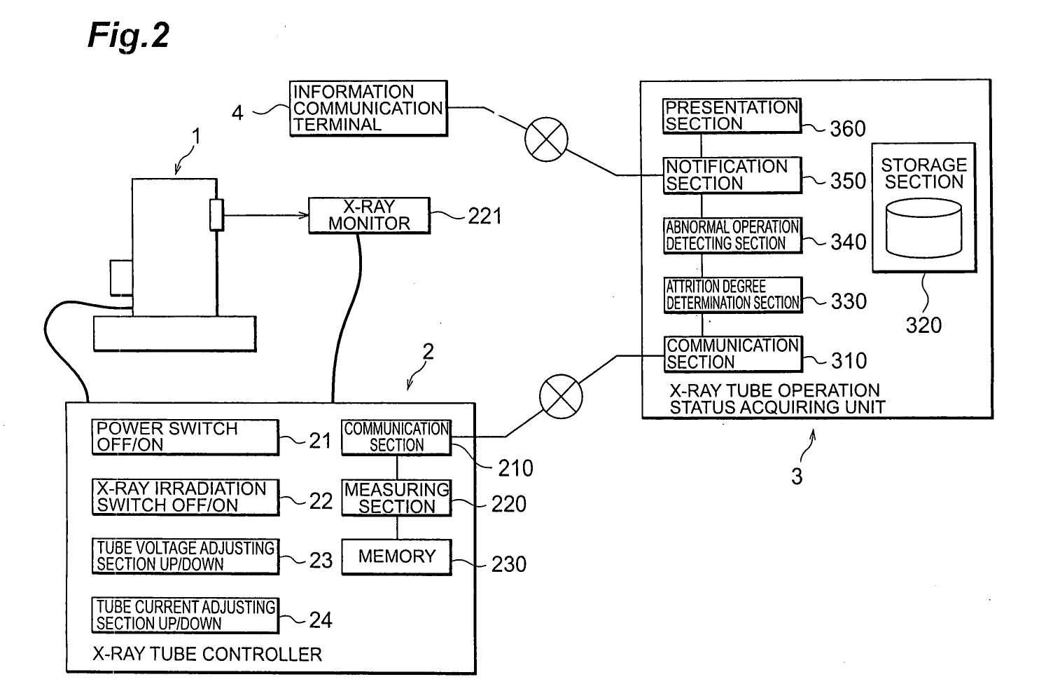

Next, the functional configuration of the X-ray tube operation status acquiring system in the first embodiment will be described. FIG. 2 is a diagram showing the functional configuration of the system in the first embodiment. As shown in FIG. 2, the X-ray tube operation status acquiring system in the first embodiment comprises an X-ray tube controller 2 (X-ray tube measuring apparatus) and an X-ray tube operation status acquiring unit 3. The X-ray tube controller 2 is located at the user site of the X-ray tube 1. The X-ray tube controller 2 controls the X-ray tube 1 and measures the operation status of the X-ray tube 1. Also, the X-ray tube controller 2 has a function to transmit the operation information about the operation status of the X-ray tube 1 to the X-ray tube operation status acquiring unit 3 via a communication line. Further, at the user site of the X-ray tube 1, an information communication terminal 4 is installed. The information communication terminal 4 has a function to obtain notification information, which is transmitted from the unit 3 via a communication line to present the information to the user. The X-ray tube operation status acquiring unit 3 is located at the site of the management and maintenance provider of the X-ray tube 1, and has a function to control the X-ray tube 1 via a communication line.

The X-ray tube controller 2 is connected to the X-ray tube 1 via the control cable 16. The X-ray tube controller 2 comprises a power switch 21, which changes over between activation and shutoff of the X-ray tube 1, the X-ray irradiation switch 22, which changes over between irradiation and standby of the X-ray during activation of the X-ray tube 1, a tube voltage adjusting section 23, which adjusts the level of the tube voltage, a tube current adjusting section 24, which adjusts the strength of the tube current, a communication section 210 (transmission means, receiving means), which has a function to communicate with the X-ray tube operation status acquiring unit 3 via the communication line, a measuring section 220 (measuring means), which measures the operation status of the X-ray tube 1 and a memory 230, which stores the operation information.

As described above, when the power switch 21 turns ON, the power is supplied to each part of the X-ray tube 1, and the X-ray tube 1 begins warming up. During the standby of irradiation of the X-ray, when the X-ray irradiation switch 22 turns ON, the voltage value of the first grid electrode switches from the cut-OFF voltage value to the G1 voltage value. Thereby, the tube current flows and the target 150 generates the X-ray. By using the up-button and the down-button in the tube voltage adjusting section 23, the preset tube voltage of the X-ray tube 1 can be adjusted. Likewise, by using the up-button and the down-button in the tube current adjusting section 24, the preset tube current of the X-ray tube 1 can be adjusted. The measuring section 220 measures the operation status of the X-ray tube 1 and obtains the operation information about the operation status of the X-ray tube 1. As for the content of the operation information, a description will be given in the description of the operation status of the X-ray tube operation status acquiring system of the first embodiment, which will be described later. The measuring section 220 is provided with an X-ray monitor 221, which has a function to measure the strength of the irradiated X-ray of the X-ray tube 1 in the operation status. The X-ray monitor 221 is connected to the X-ray tube controller main body via a cable, and is located in an irradiation area of the X-ray of the X-ray tube 1. The operation information obtained by the measuring section 220 is stored in the memory 230. The communication section 210 transmits the operation information stored in the memory 230 to the X-ray tube operation status acquiring unit 3 via a communication line when the activation of the X-ray tube is terminated or at specific intervals.

The X-ray tube operation status acquiring unit 3 comprises a communication section 310 (transmission means, receiving means, inputting means), a storage section 320 (storing means), an attrition degree determination section 330 (attrition degree determination means), an abnormal operation detecting section 340 (abnormal operation detecting means), a notification section 350 (determination result notifying means, detection result notifying means) and a presentation section 360 (presentation means).

The communication section 310 receives operation information, which is transmitted from the X-ray tube controller 2 via the communication line. The storage section 320 stores the operation information received by the communication section 310. The attrition degree determination section 330 determines the degree of attrition of the filament 110 and the target 150 of the X-ray tube 1 based on the operation information stored in the storage section 320. The abnormal operation detecting section 340 detects electric discharge phenomenon in the X-ray tube 1 based on the operation information stored in the storage section 320. The notification section 350 notifies the determination result by the attrition degree determination section 330 and the detection result by the abnormal operation detecting section 340 to the information communication terminal 4 via the communication line. The presentation section 360 presents the operation information stored in the storage section 320 on a display.

Next, a first operation (an operation in which the attrition degree determination section 330 determines the degree of attrition of the filament 110 based on the filament power supply time) of the X-ray tube operation status acquiring system according to the first embodiment and the effect thereof will be described.

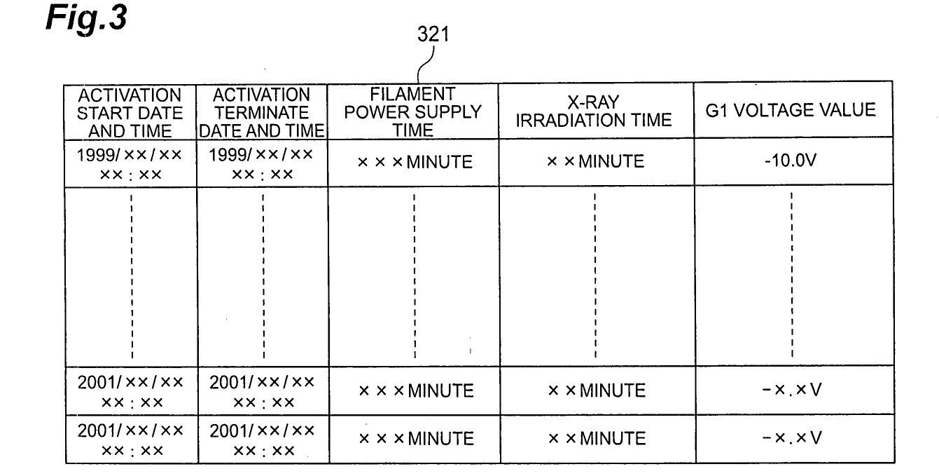

FIG. 3 is a diagram showing the content of a file 321 about the attrition degree determination of the filament 110 included in the operation information. As shown in FIG. 3, the file 321 comprises an activation start date and time field, an activation terminate date and time field, a filament power supply time field, an X-ray irradiation time field and a G1 voltage value field.

When the power switch 21 of the X-ray tube controller 2 turns ON, a predetermined voltage is applied to the filament 110. The measuring section 220 counts the time (filament power supply time) from the point when the power switch 21 turns ON.

The activation start date and time (the time when the power switch 21 turns ON), the activation terminate date and time (the time when the power switch 21 turns OFF), the filament power supply time, the X-ray irradiation time and the G1 voltage value when the irradiation of the X-ray is terminated last are recorded in the file 321 stored in the memory 230 respectively.

The file 321 is transmitted to the X-ray tube operation status acquiring unit 3 when the activation of the X-ray tube 1 is terminated. When the communication section 310 in the X-ray tube operation status acquiring unit 3 receives the file 321, the file 321 stored in the storage section 320 is updated.

The attrition degree determination section 330 counts the filament power supply time with reference to the file 321. In the storage section 320, a database, written with the degree of attrition corresponding to the integrated power supply time of the filament 110 (the reduction ratio of thermalelectron emission amount (tube current value at a predetermined G1 voltage) relative to the initial value (thermalelectron emission amount when the filament 110 is first put to use)) is stored. The attrition degree determination section 330 determines the degree of attrition of the filament 110 from the integrated power supply time with reference to the database. Here, the attrition degree determination section 330 may determine the degree of attrition of the filament 110 while taking the count of the X-ray irradiation time recorded in the file 321 into consideration.

When the degree of attrition of the filament 110 to be determined by the attrition degree determination section 330 has reached a predetermined value (for example, the count of the filament power supply time: 10,000 hours, the degree of attrition of the filament 110: 80%), the notification section 350 notifies the degree of attrition of the filament 110 to the information communication terminal 4, and transmits a notification to prompt the preparation for replacement of the filament (in the case of the sealed type, X-ray tube head).

The presentation section 360 is provided with the display, and presents the file 321 on the display.

Since a predetermined voltage is applied to the filament 110, the filament 110 deteriorates in proportion to the count of the filament power supply time. Therefore, the X-ray tube operation status acquiring unit 3 can detect the deterioration of the filament 110 from the count of the filament power supply time. As a result, the cause of failure of the X-ray tube 1 can be detected (deterioration of the filament 110) without work or time of a service person. When the information communication terminal 4 receives the notification transmitted from the notification section 350, service person can notify the deterioration of the filament 110 to the user before the filament 110 reaches the end of life without work or time to prompt the preparation for replacement of the filament (in the case of sealed type, X-ray tube head). Since the operation information is presented on the display, service person can obtain the information about the operation status of the X-ray tube 1.

When the X-ray is irradiated and when the X-ray is not irradiated, the attrition ratio of the filament per filament power supply time differs. However, the attrition degree determination section 330 can determine the degree of attrition of the filament taking the count of the X-ray irradiation time recorded in the X-ray irradiation time field of the file 321 into consideration.

Next, a second operation (an operation in which the attrition degree determination section 330 determines the degree of attrition of the filament 110 based on the level of the grid voltage) of the X-ray tube operation status acquiring system according to the first embodiment and the effect thereof will be described.

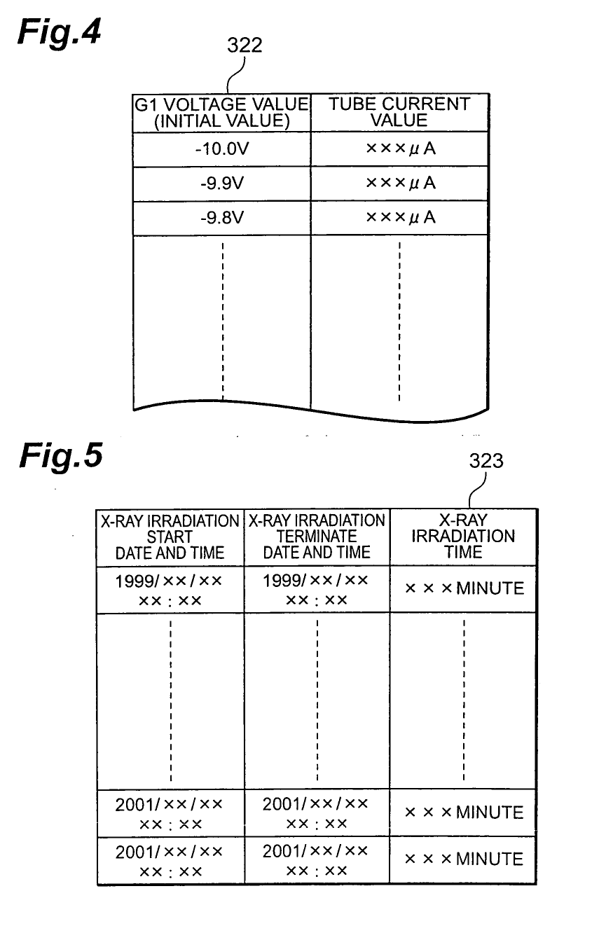

FIG. 4 is a diagram showing the content of a file 322 about the relationship between the G1 voltage value (initial value) and the tube current value of the X-ray tube 1, which is stored beforehand in the storage section 320. As shown in FIG. 4, the file 322 comprises a G1 voltage value field and a tube current value field. In the G1 voltage value field, G1 voltage values (initial value) for achieving the tube current values written in the tube current value field are written. The wording “initial value” means the G1 voltage value when the filament 110 is first put to use.

The attrition degree determination section 330 compares the latest G1 voltage value recorded in the file 321 and the file 322, and computes the reduction ratio of the absolute value of the latest G1 voltage value relative to the absolute value of the G1 voltage value (initial value) in the preset tube current value. In the storage section 320, a database written with the degree of attrition (the reduction ratio of thermalelectron emission amount (tube current value at a predetermined G1 voltage) relative to the initial value (thermalelectron emission amount when the filament 110 is first put to use)) corresponding to the reduction ratio of the absolute value of the G1 voltage relative to the absolute value of the G1 voltage (initial value), is stored. The attrition degree determination section 330 determines the degree of attrition of the filament 110 from the reduction ratio of the absolute value of the latest G1 voltage relative to the absolute value of the G1 voltage (initial value) with reference to the database.

When the degree of attrition of the filament 110 to be determined by the attrition degree determination section 330 has reached a predetermined value (for example, the reduction ratio of the absolute value of the G1 voltage relative to the absolute value of the G1 voltage (initial value): 80%, degree of attrition of the filament 110: 80%), the notification section 350 notifies the degree of attrition of the filament 110 to the information communication terminal 4, and transmits a notification to prompt the preparation for replacement of the filament (in the case of the sealed type, X-ray tube head).

The presentation section 360 is provided with the display, and presents the operation information on the display.

When the filament deteriorates and the amount of the thermoelectron emitted therefrom reduces, the G1 voltage value, which is controlled to obtain the preset tube current value, increases. Owing to this, the X-ray tube operation status acquiring unit 3 can detect the deterioration of the filament 110 by comparing the G1 voltage value of the operation information under the preset tube current value and the G1 voltage value (initial value). As a result, the cause of failure (deterioration of the filament 110) of the X-ray tube 1 can be detected without work or time of service person. By receiving a notification transmitted from the notification section 350 with the information communication terminal 4, it is possible for service person to notify the deterioration of the filament 110 to the user before the filament 110 reaches the end of life without work or time to prompt the preparation for replacement of the filament (in the case of sealed type, the X-ray tube head). By presenting the operation information on the display, service person can obtain the information about the operation status of the X-ray tube 1.

Next, a third operation (an operation in which the attrition degree determination section 330 determines the degree of attrition of the target 150 based on the X-ray irradiation time) of the X-ray tube operation status acquiring system according to the first embodiment and the effect thereof will be described.

When the X-ray irradiation switch 22 of the X-ray tube controller 2 turns ON, the level of the grid voltage applied to the first grid electrode reaches the G1 voltage value, and the tube current, which is preset for the target 150, flows. The measuring section 220 counts the time (X-ray irradiation time) from a point when the X-ray irradiation switch 22 turns ON. The memory 230 stores the X-ray irradiation time counted by the measuring section 220. The X-ray irradiation time stored in the memory 230 is transmitted by the communication section 210 to the X-ray tube operation status acquiring unit 3 at intervals of 1 second. Further, when the X-ray irradiation switch 22 turns ON, the communication section 210 transmits the date and time (X-ray irradiation start date and time); and when the X-ray irradiation switch 22 turns OFF, the communication section 210 transmits the date and time (X-ray irradiation terminate date and time) to the X-ray operation status acquiring unit 3.

When the communication section 310 of the X-ray tube operation status acquiring unit 3 receives the operation information (the X-ray irradiation time, the X-ray irradiation start date and time and the X-ray irradiation terminate date and time), the storage section 320 stores the operation information. FIG. 5 is a diagram showing the content of a file 323 about the X-ray irradiation time of the X-ray tube 1, which is included in the operation information. As shown in FIG. 5, the file 323 comprises an X-ray irradiation start date and time field, an X-ray irradiation terminate date and time field and an X-ray irradiation time field. The operation information is written in the related field in the file 323.

The attrition degree determination section 330 counts the X-ray irradiation time with reference to the file 323. In the storage section 320, a database, written with the degree of attrition corresponding to the integrated X-ray irradiation time (the reduction ratio of the X-ray dosage under a predetermined tube voltage value and tube current value relative to the initial value (X-ray amount when the target 150 is first put to use)) is stored. The attrition degree determination section 330 determines the degree of attrition of the target 150 from the counted X-ray irradiation time with reference to the database.

When the degree of attrition of the target 150 to be determined by the attrition degree determination section 330 has reached a predetermined value (for example, the count of the X-ray irradiation time: 5,000 hours, degree of attrition of the target 150: 30%), the notification section 350 transmits a notification to prompt replacement or rotation of the target 150, (in the case of the sealed type, X-ray tube head) to the information communication terminal 4. By rotating the target 150, the point where the thermoelectron beam hits in the target 150 is changed; thus, the X-ray dosage can be recovered by the rotation of the target 150.

The presentation section 360 is provided with the display, and presents the file 323 on the display.

When the tube voltage value and the tube current value are substantially constant, the target 150 deteriorates in proportion to the count of the X-ray irradiation time. Therefore, the X-ray tube operation status acquiring unit 3 can detect the deterioration of the target 150 from the count of the X-ray irradiation time. As a result, it is possible for service person to detect the cause of failure (deterioration of the target 150) of the X-ray tube 1 without work or time. By receiving the notification transmitted by the notification section 350 with the information communication terminal 4, it is possible for service person to prompt the user to replace or rotate the target 150 (in the case of the sealed type, replacement of the X-ray tube head) before the target 150 gets damaged without work or time. By presenting the operation information on the display, service person can obtain the information about the operation status of the X-ray tube 1.

Next, a fourth operation (an operation in which the attrition degree determination section 330 determines the degree of attrition of the target 150 based on the level of the tube voltage and the over-time changes in the strength of the tube current) of the X-ray tube operation status acquiring system according to the first embodiment and the effect thereof will be described.

When the X-ray irradiation switch 22 of the X-ray tube controller 2 turns ON, the measuring section 220 measures the tube voltage value and tube current value. The memory 230 stores the tube voltage value and the tube current value measured by the measuring section 220. The tube voltage value and the tube current value stored in the memory 230 are transmitted to the X-ray tube operation status acquiring unit 3 along with the transmission date and time by the communication section 210 at intervals of 1 second.

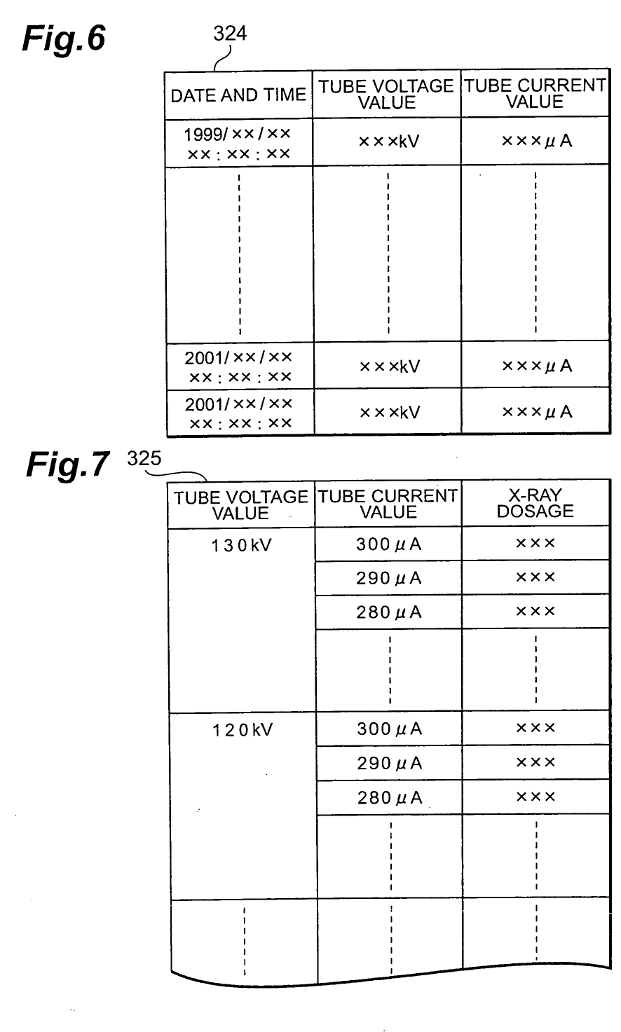

When the communication section 310 of the X-ray tube operation status acquiring unit 3 receives the operation information (the tube voltage value and the tube current value), the storage section 320 stores the operation information. FIG. 6 is a diagram showing the content of a file 324 about the over-time changes of the tube voltage value and the tube current value included in the operation information. As shown in FIG. 6, the file 324 comprises a date and time field, a tube voltage value field and a tube current value field. In the date and time field, transmission date and time of the operation information is written; in the tube voltage value field and the tube current value field, the tube voltage value and the tube current value of the operation information are written. Further, in the storage section 320, a database written with degree of attrition of the target 150 at intervals of 1 second (the reduction ratio of the X-ray dosage under a predetermined tube voltage value and tube current value relative to the initial value (X-ray dosage when the target 150 is first put to use)) in a combination of the tube voltage value and the tube current value is stored.

The attrition degree determination section 330 extracts degree of attrition at intervals of 1 second under the tube voltage value and the tube current value in the file 324 with reference to the above database, and determines the degree of attrition of the target 150 by integrating the attrition.

When the degree of attrition of the target 150 to be determined by the attrition degree determination section 330 has reached a predetermined value (for example, degree of attrition of the target 150: 30%), the notification section 350 transmits a notification to prompt replacement or rotation of the target 150, (in the case of the sealed type, X-ray tube head) to the information communication terminal 4.

The presentation section 360 is provided with the display, and presents the file 324 on the display.

By determining the degree of attrition of the target 150 from the over-time changes of the tube voltage value and the tube current value, even when the tube voltage value and the tube current value change, the X-ray tube operation status acquiring unit 3 can detect the deterioration of the target 150 precisely. As a result, it is possible for service person to detect the cause of failure (deterioration of the target 150) of the X-ray tube 1 without work or time. By receiving the notification transmitted by the notification section 350 with the information communication terminal 4, it is possible for service person to prompt the user to replace or rotate the target 150 (in the case of the sealed type, replacement of the X-ray tube head) before the target 150 gets damaged without work or time. By presenting the operation information on the display, service person can obtain the information about the operation status of the X-ray tube 1.

Next, a fifth operation (an operation in which the attrition degree determination section 330 determines the degree of attrition of the target 150 based on the strength of the X-ray) of the X-ray tube operation status acquiring system according to the first embodiment and the effect thereof will be described.

When the power switch 21 of the X-ray tube controller 2 turns ON, the warming up of the X-ray tube 1 begins. The measuring section 220 (X-ray monitor 221) measures the strength (X-ray dosage) of the X-ray during the warming up. The memory 230 stores the X-ray dosage measured by the measuring section 220, the tube voltage value and the tube current value. When the activation of the X-ray tube 1 is terminated, the X-ray dosage, the tube voltage value and the tube current value stored in the memory 230 are transmitted to the X-ray tube operation status acquiring unit 3.

When the communication section 310 of the X-ray tube operation status acquiring unit 3 receives the operation information (X-ray dosage, tube voltage value and the tube current value), the storage section 320 stores the operation information.

FIG. 7 is a diagram showing the content of a file 325 about the relationship among the tube voltage value, the tube current value and the X-ray dosage (initial value) of the X-ray tube 1 stored in the storage section 320. As shown in FIG. 7, the file 325 comprises a tube voltage value field, a tube current field and an X-ray dosage field. In the X-ray dosage field, the initial value of the X-ray dosage at the relevant tube voltage value and tube current value is written.

The attrition degree determination section 330 extracts the X-ray dosage (initial value) at the tube voltage value and tube current value in the operation information with reference to the file 325 and compares it with the X-ray dosage in the operation information. Thereby, the degree of attrition of the target 150 (the reduction ratio of the X-ray dosage at a predetermined tube voltage value and tube current value relative to the initial value (when the target 150 is put to use)) is determined.

When the degree of attrition of the target 150 to be determined by the attrition degree determination section 330 has reached a predetermined value (for example, degree of attrition of the target 150: 30%), the notification section 350 transmits a notification to prompt replacement or rotation of the target 150, (in the case of the sealed type, X-ray tube head)to the information communication terminal 4.

The presentation section 360 is provided with the display, and presents the operation information on the display.

When the target 150 deteriorates, the X-ray dosage generated under specific tube voltage value and tube current value decreases. Therefore, the X-ray tube operation status acquiring unit 3 can detect the deterioration of the target 150 by comparing the X-ray dosage (initial value) at the tube voltage value and tube current value in the operation information with the X-ray dosage in the operation information. As a result, it is possible for service person to detect the cause of failure (deterioration of the target 150) of the X-ray tube 1 without work or time. By receiving the notification transmitted from the notification section 350 with the information communication terminal 4, it is possible for service person to prompt the user to replace or rotate the target (in the case of sealed type, replacement of the X-ray tube head) before the target 150 gets damaged without work or time. By presenting the operation information on the display, it is possible for service person to obtain the information about the operation status of the X-ray tube 1.

Next, a sixth operation (an operation in which the abnormal operation detecting section 340 detects the electric discharge phenomenon in the X-ray tube 1 based on the strength of the X-ray) of the X-ray tube operation status acquiring system according to the first embodiment and the effect thereof will be described.

When the X-ray irradiation switch 22 of the X-ray tube controller 2 turns ON, the tube current flows to the target 150, and the X-ray is irradiated. The measuring section 220 (X-ray monitor 221) measures the strength (X-ray dosage) of the X-ray. The memory 230 stores the X-ray dosage measured by the measuring section 220 and the preset tube voltage value and the tube current value. The X-ray dosage, the tube voltage value and the tube current value stored in the memory 230 are transmitted to the X-ray tube operation status acquiring unit 3 by the communication section 210 at intervals of 1 second.

When the communication section 310 of the X-ray tube operation status acquiring unit 3 receives the operation information (the tube voltage value, the tube current value and the X-ray dosage), the storage section 320 stores the operation information.

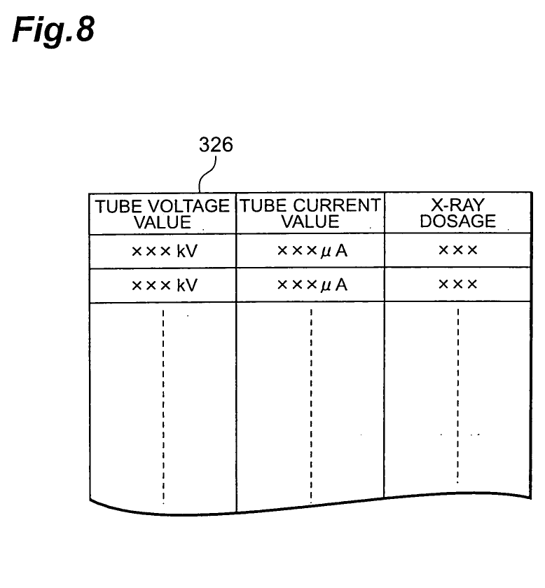

FIG. 8 is a diagram showing the content of a file 326 about the tube voltage value, the tube current value and the X-ray dosage included in the operation information. As shown in FIG. 8, the file 326 comprises a tube voltage value field, a tube current value field and an X-ray dosage field. The operation information is written in the relevant field.

The abnormal operation detecting section 340 computes the reduction ratio of the X-ray dosage at intervals of 1 second with reference to the file 326. When the reduction ratio of the X-ray dosage at specific tube voltage value and tube current value exceeds a predetermined value, the abnormal operation detecting section 340 detects electric discharge phenomenon in the X-ray tube 1.

When electric discharge phenomenon in the X-ray tube 1 is detected by the abnormal operation detecting section 340, the notification section 350 transmits an alarm that the electric discharge phenomenon has occurred to the information communication terminal 4.

The presentation section 360 is provided with the display, and presents the file 326 on the display.

When electric discharge phenomenon occurs in the X-ray tube 1, since the target 150 deteriorates, the X-ray dosage generated under specific tube voltage value and tube current value decreases. Therefore, the X-ray tube operation status acquiring unit 3 can detect the electric discharge phenomenon in the X-ray tube 1 from the fact that the X-ray dosage changes sharply at specific tube voltage value and tube current value. As a result, it is possible for service person to detect the cause of failure (occurrence of the electric discharge phenomenon) in the X-ray tube 1 without work or time. By receiving the alarm transmitted by the notification section 350 with the information communication terminal 4, it is possible for service person to raise an alarm to the user about the occurrence of the electric discharge phenomenon before the control system or the target 150 of the X-ray tube 1 gets damaged by the electric discharge phenomenon without work or time. By presenting the operation information on the display, it is possible for service person to obtain the information about the operation status of the X-ray tube 1.

### Second Embodiment

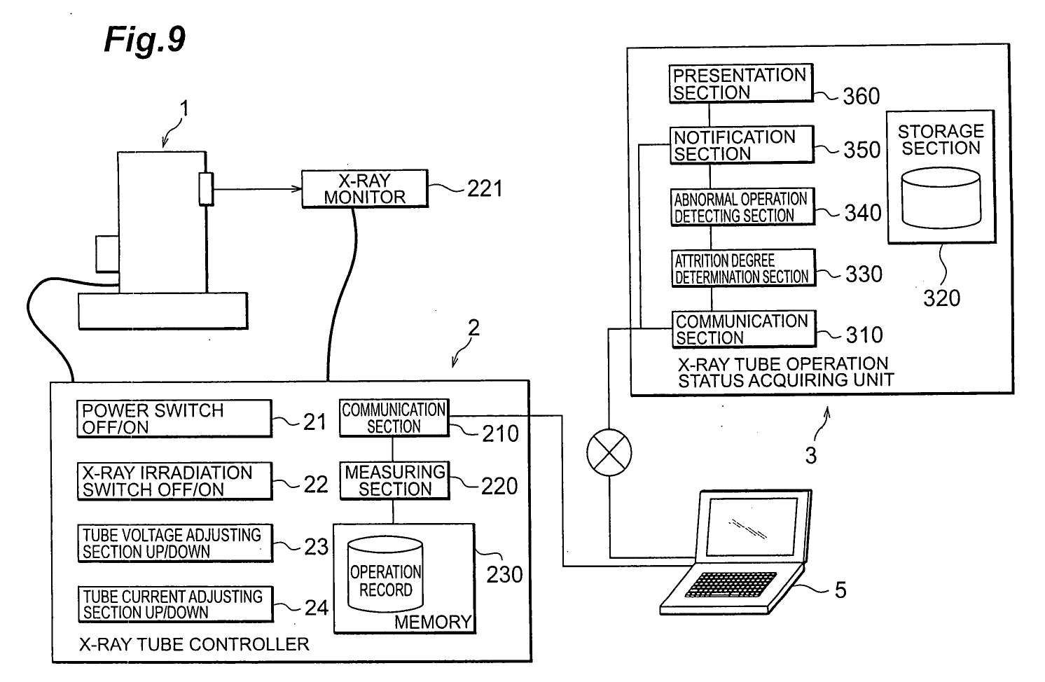

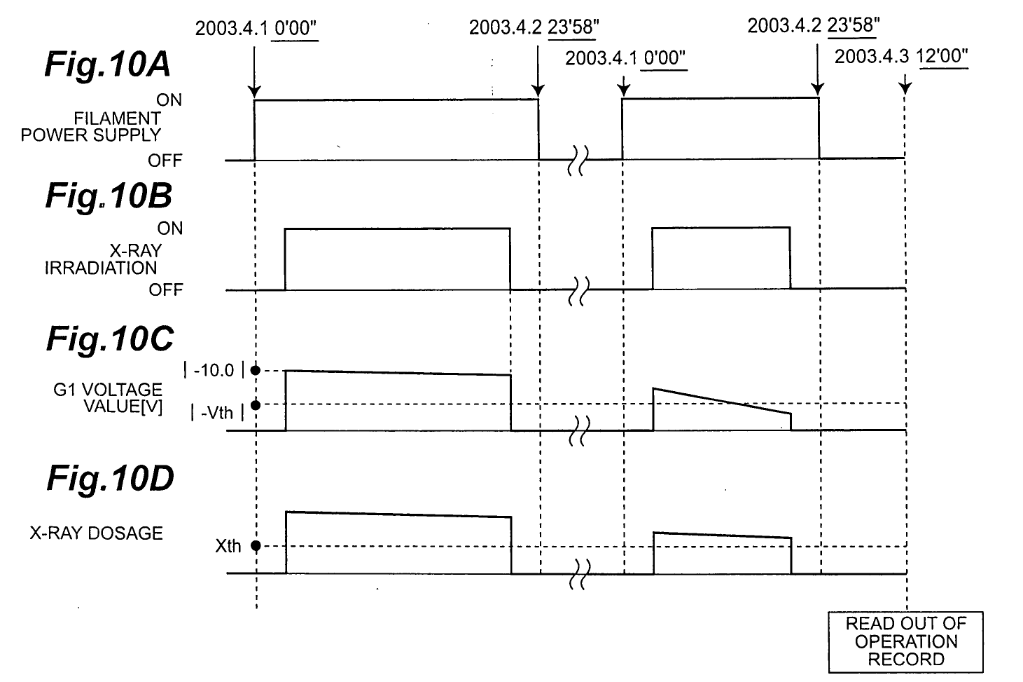

FIG. 9 is a diagram showing the functional configuration of an X-ray tube operation status acquiring system according to a second embodiment. The configuration of the X-ray tube unit and the X-ray tube operation status acquiring unit 3 is the same as that in the first embodiment. In the second embodiment, however, the tube voltage value and the tube current value of the X-ray tube 1 are fixed. In the second embodiment, the operation record (operation information) is stored in the memory 230. When service person visits the installation site of the X-ray tube 1, the service person connects a laptop PC 5 to the X-ray tube controller 2 to read the operation record stored in the memory 230 to the laptop PC 5. After that, the service person connects the laptop PC 5 to a communication line to transfer the operation record to the X-ray tube operation status acquiring unit 3.

In the operation record, information such as the filament power supply time, the X-ray irradiation time, changes of the G1 voltage value, and changes of the X-ray dosage is included. FIG. 10A is a graph showing the filament power supply time. FIG. 10B is a graph showing the X-ray irradiation time. FIG. 10C is a graph showing changes of the G1 voltage value. FIG. 10D is a graph showing changes of the X-ray dosage (strength of the X-ray). In FIGS. 10A-D, an example, in which after the previous collection of the operation record was carried out at 0:00 on Apr. 1, 2003, the first activation of the X-ray tube 1 was made; and the collection of the operation record this time is made at 12:00 on Apr. 3, 2005, is shown.

By carrying out the same operation as that in the first embodiment, the attrition degree determination section 330 determines degree of attrition of the filament 110 from the filament power supply time included in the operation record. By comparing the latest G1 voltage value with a threshold −Vth [V], the attrition degree determination section determines the end of life of the filament 110. In FIG. 10D, the X-ray dosage is maintained over a threshold Xth. But, in FIG. 10C, since the latest G1 voltage value is higher than the threshold −Vth [V], it is determined that the end of life of the filament 110 has been reached.

By carrying out the same operation as that in the first embodiment, the attrition degree determination section 330 determines the degree of attrition of the target 150 from the X-ray irradiation time included in the operation record. Also, when the latest X-ray dosage is lower than the threshold Xth, the attrition degree determination section 330 determines that the end of life of the target 150 has been reached.

The above determination result by the attrition degree determination section 330 is transmitted to the laptop PC 5 via the communication line. Based on the determination result transmitted to the laptop PC 5, service person can notify the user of the status of the X-ray tube 1.

As a modification of the present embodiment, the following example is conceivable. That is, the X-ray tube controller is provided with an attrition degree determination section, and the attrition degree determination section determines the degree of attrition of the filament and target and occurrence of electric discharge phenomenon from the operation record stored in a memory.

### INDUSTRIAL APPLICABILITY

The X-ray tube operation status acquiring unit and the X-ray tube operation status acquiring method of the present invention are applicable to, for example, the control of medical X-ray generators.

1. An X-ray tube operation status acquiring unit, comprising:
receiving means for receiving operation information about operation status of an X-ray tube transmitted from an X-ray tube measuring apparatus for measuring the operation status of said X-ray tube via a communication line, and
storing means for storing said operation information received by said receiving means.

2. The X-ray tube operation status acquiring unit according to claim 1, wherein said operation information includes filament power supply time.

3. The X-ray tube operation status acquiring unit according to claim 1 or 2, in which said operation information includes a level of a grid voltage applied to grid electrodes so as to maintain the value of the tube current flowing to a target to a certain level in a state where a predetermined tube voltage is applied to said target of said X-ray tube.

4. The X-ray tube operation status acquiring unit according to claim 1, wherein said operation information includes X-ray irradiation time.

5. The X-ray tube operation status acquiring unit according to claim 1 or 4, in which said operation information includes a level of the tube voltage applied to the target of said X-ray tube and a strength of the tube current flowing to said target.

6. The X-ray tube operation status acquiring unit according to claim 1 or 4, in which said operation information includes a strength of the X-ray generated by thermoelectron collided with said target in a state where a predetermined tube voltage is applied to the target of said X-ray tube and a predetermined tube current flows to said target.

7. The X-ray tube operation status acquiring unit as in any of claims 1-6, further comprising attrition degree determination means for determining the degree of attrition of component constituting said X-ray tube based on said operation information.

8. The X-ray tube operation status acquiring unit according to claim 7, in which
said X-ray tube is provided with a filament for emitting thermoelectron by being supplied with power;
said operation information includes filament power supply time;
said attrition degree determination means determines the degree of attrition of said filament based on said filament power supply time.

9. The X-ray tube operation status acquiring unit according to claim 7 or 8, in which
said X-ray tube is provided with a filament for emitting thermoelectron by being supplied with power;
said operation information includes a level of a grid voltage applied to grid electrodes so as to maintain the value of the tube current flowing to said target to a certain level in a state where a predetermined tube voltage is applied to the target of said X-ray tube;
said attrition degree determination means determines the degree of attrition of said filament based on the level of said grid voltage.

10. The X-ray tube operation status acquiring unit as in any of claims 7-9, in which
said operation information includes X-ray irradiation time;
said attrition degree determination means determines the degree of attrition of the target of said X-ray tube based on said X-ray irradiation time.

11. The X-ray tube operation status acquiring unit as in any of claims 7-10, in which
said operation information includes a level of the tube voltage applied to the target of said X-ray tube and a strength of the tube current flowing to said target;
said attrition degree determination means determines the degree of attrition of said target based on the over-time changes of the level of said tube voltage and the strength of said tube current.

12. The X-ray tube operation status acquiring unit as in any of claims 7-11, in which
said operation information includes a strength of the X-ray generated by thermoelectron collided with said target in a state where a predetermined tube voltage is applied to the target of said X-ray tube and a predetermined tube current flows to said target;
said attrition degree determination means determines the degree of attrition of said target based on the strength of said X-ray.

13. The X-ray tube operation status acquiring unit as in any of claims 7-12, further comprising determination result notifying means for notifying determination result by said attrition degree determination means to an information communication terminal via a communication line.

14. The X-ray tube operation status acquiring unit as in any of claims 1-13, further comprising abnormal operation detecting means for detecting abnormal operation of said X-ray tube based on said operation information.

15. The X-ray tube operation status acquiring unit according to claim 14, wherein
said operation information includes a strength of the X-ray generated by thermoelectron collided with said target of said X-ray tube in a state where a predetermined tube voltage is applied to the target of said X-ray tube and a predetermined tube current flows to said target;
said abnormal operation detecting means detects occurrence of electric discharge phenomenon in said X-ray tube based on the strength of said X-ray.

16. The X-ray tube operation status acquiring unit according to claim 14 or 15, further comprising detection result notifying means for notifying detection result by said abnormal operation detecting means to an information communication terminal via a communication line.

17. The X-ray tube operation status acquiring unit as in any of claims 1-16, further comprising presentation means for presenting said operation information stored in said storing means on a display.

18. An X-ray tube operation status acquiring system for controlling the operation status of an X-ray tube, comprising:
an X-ray tube measuring apparatus including measuring means for measuring operation status of said X-ray tube and transmission means for transmitting operation information of said X-ray tube obtained by said measuring means by measuring the operation status of said X-ray tube to an information communication terminal via a communication line, and X-ray tube operation status acquiring unit as in any of claims 1-17, wherein
receiving means of said X-ray tube operation status acquiring unit receives said operation information transmitted by transmission means of said X-ray tube measuring apparatus;
storing means of said X-ray tube operation status acquiring unit stores said operation information received by the receiving means of said X-ray tube operation status acquiring unit.

19. An X-ray tube operation status acquiring method, comprising:
a receiving step in which receiving means receives operation information about operation status of said X-ray tube transmitted from an X-ray tube measuring apparatus for measuring the operation status of the X-ray tube via a communication line, and
a storing step in which storing means stores said operation information received by said receiving means.

20. The X-ray tube operation status acquiring method according to claim 19, wherein said operation information includes filament power supply time.

21. The X-ray tube operation status acquiring method according to claim 19 or 20, in which said operation information includes a level of a grid voltage applied to grid electrodes so as to maintain the value of the tube current flowing to said target to a certain level in a state where a predetermined tube voltage is applied to the target of said X-ray tube.

22. The X-ray tube operation status acquiring method according to claim 19, wherein said operation information includes X-ray irradiation time.

23. The X-ray tube operation status acquiring method according to claim 19 or 22, in which said operation information includes a level of the tube voltage applied to the target of said X-ray tube and a strength of the tube current flowing to said target.

24. The X-ray tube operation status acquiring method according to claim 19 or 22, in which said operation information includes a strength of the X-ray generated by thermoelectron collided with said target in a state where a predetermined tube voltage is applied to the target of said X-ray tube and a predetermined tube current flows to said target.

25. The X-ray tube operation status acquiring method as in any of claims 19-24, further comprising an attrition degree determination step in which attrition degree determination means determines the degree of attrition of component constituting said X-ray tube based on said operation information.

26. The X-ray tube operation status acquiring method according to claim 25, in which
said X-ray tube is provided with a filament for emitting thermoelectron by being supplied with power;
said operation information includes filament power supply time;
said attrition degree determination means determines the degree of attrition of said filament based on said filament power supply time.

27. The X-ray tube operation status acquiring method according to claim 25 or 26, in which
said X-ray tube is provided with a filament for emitting thermoelectron by being supplied with power;
said operation information includes a level of a grid voltage applied to grid electrodes so as to maintain the value of the tube current flowing to said target to a certain level in a state, where a predetermined tube voltage is applied to the target of said X-ray tube;
said attrition degree determination means determines the degree of attrition of said filament based on the level of said grid voltage.

28. The X-ray tube operation status acquiring method as in any of claims 25-27, in which
said operation information includes X-ray irradiation time;
said attrition degree determination means determines the degree of attrition of the target of said X-ray tube based on said X-ray irradiation time.

29. The X-ray tube operation status acquiring method as in any of claims 25-28, in which
said operation information includes a level of the tube voltage applied to the target of said X-ray tube and a strength of the tube current flowing to said target;
said attrition degree determination means determines the degree of attrition of said target based on the over-time changes of the level of said tube voltage and the strength of said tube current.

30. The X-ray tube operation status acquiring method as in any of claims 25-29, in which
said operation information includes strength of the X-ray generated by thermoelectron collided with said target in a state where a predetermined tube voltage is applied to the target of said X-ray tube and a predetermined tube current flows to said target;
said attrition degree determination means determines the degree of attrition of said target based on the strength of said X-ray.

31. The X-ray tube operation status acquiring method as in any of claims 25-30, further comprising a determination result notifying step, in which determination result notifying means notifies determination result by said attrition degree determination means to an information communication terminal via a communication line.

32. The X-ray tube operation status acquiring method as in any of claims 19-31, further comprising an abnormal operation detecting step, in which abnormal operation detecting means detects abnormal operation of said X-ray tube based on said operation information.

33. The X-ray tube operation status acquiring method according to claim 32, wherein
said operation information includes a strength of the X-ray generated by thermoelectron collided with said target of said X-ray tube in a state where a predetermined tube voltage is applied to the target of said X-ray tube and a predetermined tube current flows to said target;
said abnormal operation detecting means detects occurrence of electric discharge phenomenon in said X-ray tube based on the strength of said X-ray.

34. The X-ray tube operation status acquiring method according to claim 32 or 33, further comprising a detection result notifying step, in which detection result notifying means notifies detection result by said abnormal operation detecting means to an information communication terminal via a communication line.

35. The X-ray tube operation status acquiring method as in any of claims 19-34, further comprising a presentation step, in which presentation means presents said operation information stored in said storing means on a display.

36. An X-ray tube operation status acquiring unit for obtaining operation information about operation status of an X-ray tube equipped with a filament for emitting thermoelectron by being supplied with power, comprising:
inputting means for inputting operation information of said X-ray tube outputted from an X-ray tube measuring apparatus for measuring operation status of said X-ray tube and including at least filament power supply time and value of grid voltage applied to grid electrodes so as to maintain the value of tube current flowing to a target in a state where a predetermined tube voltage is applied to said target of said X-ray tube, and
attrition degree determination means for determining degree of attrition of said filament based on said filament power supply time and said grid voltage value.

37. An X-ray tube operation status acquiring unit for obtaining operation information about operation status of an X-ray tube, comprising:
inputting means for inputting operation information of said X-ray tube outputted from an X-ray tube measuring apparatus for measuring operation status of said X-ray tube and including at lest X-ray irradiation time and strength of X-ray generated by thermoelectron collided with a target in a state where a predetermined tube voltage is applied to said target of said X-ray tube and a predetermined tube current flows to said target, and
attrition degree determination means for determining degree of attrition of said target based on said X-ray irradiation time and the strength of said X-ray.

38. An X-ray tube operation information acquiring method for obtaining operation information about operation status of an X-ray tube equipped with a filament for emitting thermoelectron by being supplied with power, comprising:
a first step for obtaining operation information of said X-ray tube outputted from an X-ray tube measuring apparatus for measuring operation status of said X-ray tube and including at least filament power supply time and a value of grid voltage applied to grid electrodes so as to maintain the value of tube current flowing to a target in a state where a predetermined tube voltage is applied to said target of said X-ray tube, and
a second step for determining degree of attrition of said filament based on said filament power supply time and said grid voltage value.

39. An X-ray tube operation information acquiring method for obtaining operation information about operation status of an X-ray tube, comprising:
a first step for obtaining operation information of said X-ray tube outputted from an X-ray tube measuring apparatus for measuring operation status of said X-ray tube and including at lest X-ray irradiation time and a strength of X-ray generated by thermoelectron collided with a target in a state where a predetermined tube voltage is applied to said target of said X-ray tube and a predetermined tube current flows to said target, and
a second step for determining degree of attrition of said target based on said X-ray irradiation time and the strength of said X-ray.
